(19) United States
(12) Patent Application Publication
(10) Pub. No.: US 2006/0153595 A1
(43) Pub. Date: Jul. 13, 2006

(54) Developer driving apparatus and image forming apparatus including the same

(75) Inventors: Young-Min Yoon, Yongin-si (KR); Byeong-Hwa Ahn, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/238,020

(22) Filed: Sep. 29, 2005

(30) Foreign Application Priority Data
Jan. 13, 2005 (KR) 2005-0003185

(51) Int. Cl. G03G 15/01

(52) U.S. Cl. 399/228

(57) ABSTRACT

A developer driving apparatus and an image forming apparatus including the developer driving apparatus are provided. The developer driving apparatus includes a driving source; a power transmitting unit, and a power controlling unit. The power transmitting unit selectively transmits power generated by the driving source to development rollers of the developers to drive the developers. The power controlling unit is provided between the driving source and the power transmitting unit and controls the power so that the power is transmitted to the corresponding developer. Accordingly, the plurality of the drive developers can be driven using two power controlling units, that is, two electronic clutches, unlike conventional apparatuses that use four electronic clutches. Accordingly, the manufacturing cost of the image forming apparatus can be reduced. Also, the number of the power controlling units can be reduced and the space occupied by the power controlling units can be reduced. Thus, the developer driving apparatus and the image forming apparatus can be made more compact.

### CROSS-REFERENCE TO RELATED PATENT APPLICATIONS

This application claims the benefit under 35 U.S.C. §119(a) of Korean Patent Application No. 10-2005-0003185, filed on Jan. 13, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a developer driving apparatus for selectively operating a plurality of developers to develop an electrostatic latent image formed on a photosensitive body, and an image forming apparatus including the developer driving apparatus.

2. Description of the Related Art

Generally, a conventional image forming apparatus performs numerous processes. During a charging process, a charging unit charges the surface of a photosensitive body to a predetermined potential. During an irradiating process, a light scanning unit such as a laser scanning unit irradiates light onto the surface of the photosensitive body to form an electrostatic latent image thereon. During a developing process, a developing agent such as toner is supplied onto the electrostatic latent image to develop it into a visible image such as a toner image. During a sheet feeding process, a sheet of paper is picked up from a sheet feeding cassette and conveyed along a conveying path. During a transferring process, the visible image formed on the photosensitive body is transferred onto the sheet. During a fixing process, the transferred visible image is fixed onto the sheet of paper via high temperature and high pressure. During a discharging process, the sheet of paper with the fixed visible image is discharged from the image forming apparatus.

In the developing process, the developing agent is supplied onto the photosensitive body by a potential difference between the photosensitive body and the developer. For a mono-color image forming apparatus, one developer is used to form a mono-color image. For a color image forming apparatus, a plurality of (typically, four) developers are sequentially used to form a color image.

FIG. 1 illustrates an example of a conventional image forming apparatus that includes a photosensitive body 10, a charging unit 11 for charging the photosensitive body 10, a laser scanning unit (LSU) 12 for scanning light onto the charged photosensitive body 10 to form an electrostatic latent image, a developing unit 13 for developing the electrostatic latent image with color toners, that is, for black, yellow, magenta, and cyan toners, a transfer belt 14 for sequentially overlapping the four color toner images developed on the photosensitive body 10, a first transfer roller 14a for transferring the toner image developed on the photosensitive body 10 onto the transfer belt 14, a second transfer roller 14b for transferring the image from the transfer belt onto a sheet of paper, and a fixing unit 15 for heating and pressing the sheet of paper to fix the transferred image thereon. Also, the development rollers 13a-K, 13a-Y, 13a-M, and 13a-C of the four developers 13-K, 13-Y, 13-M, and 13-C included in the developer unit 13 are arranged at a predetermined gap from the photosensitive body 10 and sequentially receive a development bias voltage to develop the electrostatic latent image on the photosensitive body 10. The image forming apparatus also includes a sheet feeding cassette 16, a blade 17 for cleaning the photosensitive body 10, a charge eraser 18, and a conveying path 19 for discharging the sheet of paper.

In this structure, an image forming process is performed as follows. First, when the photosensitive body 10 is charged by a charging unit 11, the LSU 12 scans light onto the photosensitive body 10 to form an electrostatic latent image to be developed with a first color toner. For example, if black is the first color developed, a predetermined bias voltage is applied to the black development roller 13a-K and then the development roller 13a-K is driven by a developing unit driving motor (not shown) so that toner (T) on the peripheral surface thereof is transferred onto the electrostatic latent image portion of the photosensitive body 10. The developed black image is transferred onto the transfer belt 14 through a first transfer nip N1. Next, an electrostatic latent image of a second color is formed by charging and irradiating the photosensitive body 10 again. For example, if yellow is the second color developed, a predetermined bias voltage is applied to the yellow development roller 13a-Y and then the development roller 13a-Y is driven to develop a yellow electrostatic latent image on the photosensitive body 10. The developed yellow image is overlapped and transferred onto the transfer belt 14 on which the black image was transferred. Similarly, magenta and cyan images are developed and transferred to form a desired color image on the transfer belt 14. Then, the color image is transferred onto the sheet supplied by a second transfer nip N2 between the transfer belt 14 and the second transfer roller 14b. The transferred image is fixed to the sheet by heating and pressing the sheet while it passes through the fixing unit 15.

FIG. 2a illustrates a schematic structure of an apparatus for driving a developing unit illustrated in FIG. 1, and FIG. 2b is a plan view of an apparatus for driving a developer.

The development rollers 13a-K, 13a-Y, 13a-M, 13a-C are sequentially arranged at the periphery of the photosensitive body 10 with a predetermined gap. A reduction gear 31 is connected to a pinion gear 30 of the developing unit driving motor (not shown) and the reduction gear 31 is connected to the development roller gears 20-K, 20-Y, 20-M, an 20-C through idle gears 32, 33, 34, and 35 and an electronic clutch 36. The electronic clutch 36 corresponds to the development roller 13a and the idle gears 32, 33, 34, and 35 are arranged between the reduction gear 31 and the electronic clutch 36 by a suitable ratio so that the torque of the gear 30 of the developing unit driving motor 30 is transmitted to the electronic clutch 36. Both ends of the electronic clutch 36 are respectively provided with a first gear 37 connected to the idle gear 34 and a second gear 38 connected to the development roller gear 20. When the electronic clutch 36 is turned on, the torque of the first gear 37 is transmitted to the second gear 38 and the development roller gear 20 and, when the electronic clutch 36 is turned off, the connection between the first gear 37 and the second gear 38 is released.

The operation of the developer driving apparatus having the above-mentioned structure will be described with reference to the attached drawings. First, when using the black developer 13-K, the developing unit driving motor and the gear 30 are rotated in the counter-clockwise direction. According to the rotation of the developer driving gear 30, the first gears 37-K, 36-Y of the electronic clutches 36-K, 36-Y connected to the first idle gear 32 and the first gears 37-M, 36-C of the electronic clutches 36-M, 36-C connected to the second through fourth idle gears 33, 34, and 35 are rotated. Subsequently, when the electronic clutch 36-K for the black developer 13-K is turned on, the torque of the first gear 37-K is transmitted to the second gear 38-K and thus the development roller gear 20-K and the development roller 13a-K are driven. At this time, the development bias voltage is applied to the development roller 13a-K and thus the toner on the surface of the development roller 13a-K develops the electrostatic latent image on the photosensitive body 10.

Subsequently, when driving the yellow development roller 13a-Y, the development bias voltage is no longer applied to the black development roller 13a-K and the electronic clutch 36-K is turned off, and the development bias voltage is applied to the yellow development roller and the electronic clutch 36-Y is turned on. Thus, the torque of the first gear 37-Y, which is rotating, is transmitted to the second gear 38-Y, and the development roller gear 20-Y and the development roller 13a-Y are driven. Magenta and cyan images are sequentially developed in the same manner.

As mentioned above, since the developer driving apparatus must have as many electronic clutches as developers in order to selectively drive the developers, the manufacturing cost of the image forming apparatus is high.

Accordingly, there is a need for an improved apparatus for driving a developer in an image forming apparatus.

### SUMMARY OF THE INVENTION

An aspect of the present invention is to solve at least the above problems and/or disadvantages and to provide at least the advantages described below. Accordingly, an aspect of the present invention is to provide a developer driving apparatus and an image forming apparatus by which the number of expensive electronic clutches can be reduced.

According to an aspect of the present invention, a developer driving apparatus for an image forming apparatus selectively operates a plurality of developers to develop an electrostatic latent image of a predetermined color on a photosensitive body. The developer driving apparatus comprises a driving source, a power transmitting unit, and a power controlling unit. The power transmitting unit selectively transmits power generated by the driving source to development rollers of the developers to drive the developers. The power controlling unit is provided between the driving source and the power transmitting unit so that the power is transmitted to the corresponding developer.

In an exemplary embodiment of the present invention, the power transmitting unit may be selectively placed into contact with or be separated from the development rollers of the developers.

In another exemplary embodiment of the present invention, the power transmitting unit may comprise a development roller driving unit and a controlling unit. The development roller driving unit is reciprocally moved between predetermined locations to selectively transmit the power controlled by the power controlling unit to the development rollers of the developers. The controlling unit controls the reciprocal movement of the development roller driving unit such that the development roller driving unit is selectively placed into contact with or separated from the development rollers of the developers.

In yet another exemplary embodiment of the present invention, the development roller driving unit may comprise power transmitting gears and an arm. The power transmitting gears receive the power from the power controlling unit and transmit the power to the development rollers of the developers. A shaft to which the power controlling unit is coupled is rotatably installed in the arm.

In a further exemplary embodiment of the present invention, the power transmitting gears may include first and second power transmitting gears, and the development roller may include first, second, third, and fourth development rollers. The first power transmitting gear may be reciprocally moved between the first and second development rollers to selectively drive the development rollers, and the second power transmitting gear may be reciprocally moved between the third and fourth development rollers to selectively drive the development rollers.

In one more exemplary embodiment of the present invention, one end of the arm may be rotatably coupled to the controlling unit.

In another exemplary embodiment of the present invention, the controlling unit may comprise a plunger coupled to one end of the arm and reciprocally moving the arm, and a solenoid. The plunger reciprocates into and out of the solenoid.

In yet another exemplary embodiment of the present invention, when the solenoid is turned on and the plunger is moved into the solenoid, the first and second power transmitting gears may be engaged with the gears of the second and fourth development rollers. When the solenoid is turned off and the plunger is moved out of the solenoid, the first and second transmitting gears may be engaged with the gears of the first and third development rollers.

In one more exemplary embodiment of the present invention, an elastic member that provides an elastic force to move the plunger out of the solenoid when the solenoid is turned off may be included.

In another exemplary embodiment of the present invention, the power controlling unit may comprise a first power controlling unit and a second power controlling unit. The first power controlling unit controls the power transmitted to the first power transmitting gear, and the second power controlling unit controls the power transmitted to the second power transmitting gear.

According to another aspect of the present invention, an image forming apparatus includes a developer driving apparatus that selectively operates a plurality of developers to develop an electrostatic latent image of a predetermined color on a photosensitive body. The developer driving apparatus comprises a driving source, a power transmitting unit, and a power controlling unit. The power transmitting unit selectively transmits power generated by the driving source to development rollers of the developers to drive the developers. The power controlling unit is provided between the driving source and the power transmitting unit and controls the power so that the power is transmitted to the corresponding developer.

In an exemplary embodiment of the present invention, the power transmitting unit may be selectively placed into contact with or be spaced from the development rollers of the developers.

In another exemplary embodiment of the present invention, the power transmitting unit may comprise a development roller driving unit and a controlling unit. The development roller driving unit is reciprocally moved between predetermined locations to selectively transmit the power controlled by the power controlling unit to the development rollers of the developers. The controlling unit controls the reciprocal movement of the development roller driving unit such that the development roller driving unit is selectively placed into contact with or separated from the development rollers of the developers.

In yet another exemplary embodiment of the present invention, the development roller driving unit may comprise power transmitting gears and an arm. The power transmitting gears receive the power from the power controlling unit and transmit the power to the development rollers of the developers. A shaft to which the power controlling unit is coupled is rotatably installed in the arm.

In a further exemplary embodiment of the present invention, the power transmitting gears may include first and second power transmitting gears, and the development rollers may include first, second, third and fourth development rollers. The first power transmitting gear may be reciprocally moved between the first and second development rollers to selectively drive the development rollers and the second power transmitting gear may be reciprocally moved between the third and fourth development rollers to selectively drive the development rollers.

In one more exemplary embodiment of the present invention, one end of the arm may be rotatably coupled to the controlling unit.

In another exemplary embodiment of the present invention, the controlling unit may comprise a plunger coupled to one end of the arm and reciprocally moving the arm, and a solenoid. The plunger reciprocates into and out of the solenoid.

In yet another exemplary embodiment of the present invention, when the solenoid is turned on and the plunger is moved into the solenoid, the first and second power transmitting gears may be engaged with the gears of the second and fourth development rollers. When the solenoid is turned off and the plunger is moved out of the solenoid, the first and second transmitting gears may be engaged with the gears of the first and third development rollers.

In one more exemplary embodiment of the present invention, an elastic member that provides an elastic force to move the plunger out of the solenoid when the solenoid is turned off may be included.

In another exemplary embodiment of the present invention, the power controlling unit may comprise a first power controlling unit and a second power controlling unit. The first power controlling unit controls the power transmitted to the first power transmitting gear; and the second power controlling unit controls the power transmitted to the second power transmitting gear.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic view of a conventional image forming apparatus;

FIG. 2a is a schematic view of the structure of an apparatus for driving the developing unit illustrated in FIG. 1;

FIG. 2b is a plan view of the apparatus for driving a developer illustrated in FIG. 2a;

FIG. 3 is a cross-sectional schematic view of an image forming apparatus according to an exemplary embodiment of the present invention;

FIG. 4 is a perspective view of the developer illustrated in FIG. 3;

FIG. 5 illustrates the structure of a developer driving apparatus according to an exemplary embodiment of the present invention;

FIG. 6 illustrates the structure of another developer driving apparatus according to an exemplary embodiment of the present invention;

FIG. 7 illustrates the developer driving apparatus illustrated in FIG. 5 when it is coupled to a bracket;

FIG. 8 is a perspective view of FIG. 7;

FIGS. 9 to 12 illustrate the operation of the developer driving apparatus according to an exemplary embodiment of the present invention, wherein FIG. 9 illustrates the case of driving a first developer, FIG. 10 illustrates the case of driving a second developer, FIG. 11 illustrates the case of driving a third developer, and FIG. 12 illustrates the case of driving a fourth developer.

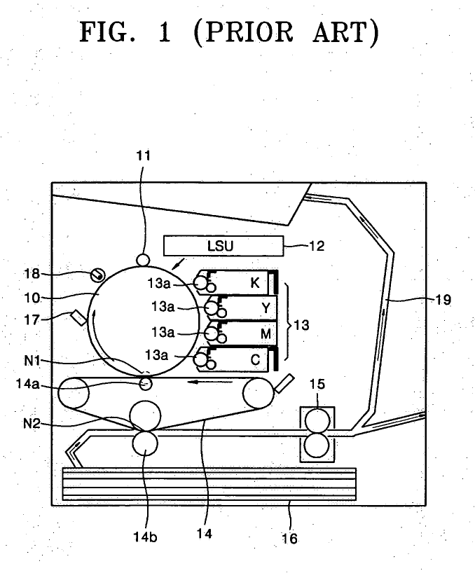

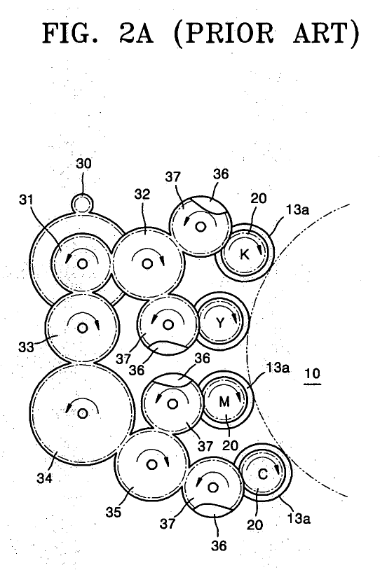

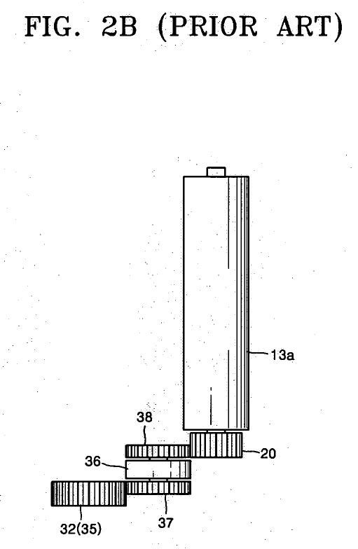

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the following description, an image forming apparatus including the developer driving apparatus according to an embodiment of the present invention will be first described, and, then, the developer driving apparatus according to an embodiment of the present invention will be described.

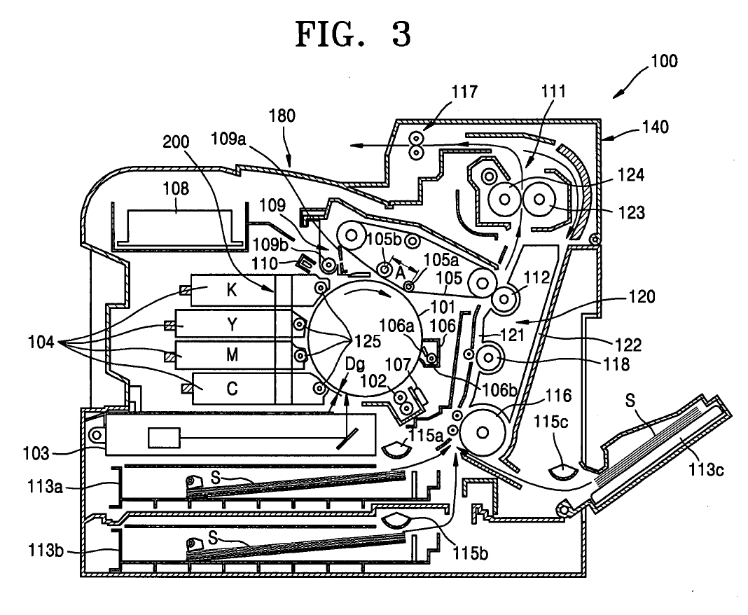

FIG. 3 is a cross-sectional view schematically illustrating an image forming apparatus according to an exemplary embodiment of the present invention. The image forming apparatus 100, including the developer driving apparatus, includes a photosensitive body 101 assembled in a frame 140, a charging roller 102, a light scanning unit 103, four developers 104C, 104M, 104Y, and 104K, and a transfer belt 105.

The peripheral surface of the photosensitive body 101 is coated with an optical conductive material layer. Preferably, the photosensitive body 101 is a cylindrical metal drum that is coated by a deposition method. A portion of the peripheral surface of the photosensitive body 101 is exposed. The photosensitive body 101 is rotated in a predetermined direction and an electrostatic latent image corresponding to an image to be printed is formed on the peripheral surface of the photosensitive body 101 by light irradiated by the light scanning unit 103.

The charging roller 102 is an example of a charging unit for charging the photosensitive body 101 to a uniform potential. The charging roller 102 charges the photosensitive body 101 while rotating either in contact with or in close proximity to the peripheral surface of the photosensitive body 101 so that the peripheral surface of the photosensitive body 101 has a uniform potential. In order to charge the peripheral surface of the photosensitive body 101 to a uniform potential, a charging bias voltage is applied to the charging roller 102. Alternatively, instead of the charging roller 102, a corona charging unit (not shown) may be used to charge the photosensitive body 101.

The light scanning unit 103 is provided at a lower side of the photosensitive body 101 and irradiates light for forming an electrostatic latent image onto the peripheral surface of the photosensitive body 101. The light scanning unit 103 includes a light source (not shown) for irradiating a laser beam and a beam deflector for deflecting the laser beam irradiated from the light source. A laser scanning unit having a laser diode as the light source may be used as the light scanning unit 103.

Four cartridge type developers 104C, 104M, 104Y, and 104K are detachably mounted in the frame 140. Four color toners, that is, cyan (C), magenta (M), yellow (Y) and black (K) color toners, are stored in the developers 104C, 104M, 104Y, and 104K, respectively. The developers 104C, 104M, and 104Y, and 104K include development rollers 125 for supplying the color toners to the electrostatic latent image formed on the photosensitive body 101 to form toner images on the photosensitive body 101. The developers 104C, 104M, 104Y, and 104K can be refilled when the color toner therein is exhausted.

The color toners contained in the developer 104C, 104M, 104Y, and 104K are attached to the peripheral surface of the development rollers 125 to supply the color toners onto the electrostatic latent image formed on the photosensitive body 101 and develop a toner image. A development bias voltage is applied to the development rollers 125 to supply the color toners to the photosensitive body 101.

The development rollers 125 are either placed into contact with the photosensitive body 101 or are separated from the peripheral surface of the photosensitive body 101 by a development gap (Dg) having a predetermined size. An electric field generates a force which is directed from the photosensitive body 101 to the development roller 125, and the charged toner is conveyed from the development roller 125 to the photosensitive body 101 while being reciprocally moved in a development region formed by the development gap (Dg).

A developer driving apparatus 200 for selectively driving the developers 104C, 104M, 104Y, and 104K is placed above the developers 104C, 104M, 104Y, and 104K. That is, the developer driving apparatus 200 transmits power to gears located on shafts of the development rollers 125 to selectively drive the corresponding developers 104C, 104M, 104Y, and 104K, as will be described in detail later.

In the present embodiment, the developers 104C, 104M, 104Y, and 104K are arranged in the ascending color order of cyan, magenta, yellow, and black. A different color order may be used, however. A pre-transfer erasing unit 110 is provided on the developer 104K. A light scanning unit 103 and an erasing lamp 107 are provided at the lower side of the photosensitive body 101. A sheet conveying unit 120 is provided opposite (with respect to the photosensitive body 101) from the developers 104C, 104M, 104Y, and 104K.

The toner images cyan (C), magenta (M), yellow (Y), and black (K) which are sequentially formed on the photosensitive body 101 are sequentially transferred and overlapped onto the transfer belt 105 to form color toner images. Generally, the length of the transfer belt 105 is equal to or greater than that of a sheet (S) on which the color toner image is finally formed, but may be any desired length.

A plurality of supporting rollers are provided at the inner surface of the transfer belt 105 to support and move the transfer belt 105 in a predetermined direction.

A nip roller 105a is provided at the inner surface of the transfer belt 105 such that the photosensitive body 101 and the transfer belt 105 forms a nip of length (A). A middle transfer roller 105b receives a first transfer bias voltage so that the color toner images formed on the photosensitive body 101 are transferred onto the transfer belt 105.

The transfer belt 105 faces the photosensitive body 101 in the section between the middle transfer roller 105b and the nip roller 105a such that the color toner images developed on the peripheral surface of the photosensitive body 101 are transferred from the photosensitive belt 101 onto the transfer belt 105. That is, the transfer belt 105 is supported by the plurality of the supporting rollers, and rotates along a predetermined path so that the color toner images developed on the photosensitive body 101 are transferred from the photosensitive body 101 onto the transfer belt 105.

A first cleaning unit 106 includes a first blade 106a and a first conveying means 106b. The first blade 106a contacts the surface of the photosensitive body 101 and scrapes off waste toner remaining on the surface of the photosensitive body 101 after the transfer process is completed. The first conveying means 106b conveys the waste toner to a waste toner storing unit (not shown).

A second cleaning unit 109 removes any waste toner remaining on the transfer belt 105 after the color toner images are transferred onto the sheet (S). The second cleaning unit 109 includes a second blade 109a for scraping off any waste toner remaining on the surface of the transfer belt 105 and a second conveying means 109b for conveying the waste toner to a waste toner storing unit (not shown).

A transfer roller 112 faces the surface of the transfer belt 105 that the color toner images are transferred onto. The transfer roller 112 receives a transfer bias voltage having a polarity opposite to that of the color toner images so that the color toner images are transferred from the transfer belt 105 onto the sheet (S), due to the generated electrostatic forces. The transfer roller 112 is spaced from the transfer belt 105 when the color toner images are transferred onto the transfer belt 105 from the developers. After the color toner images are completely transferred onto the transfer belt 105, the transfer roller 112 contacts the transfer belt 105 with a predetermined pressure in order to transfer the color toner images onto the sheet (S). The color toner images can also be transferred from the transfer belt 105 onto the sheet (S) by contact pressure between the transfer belt 105 and the transfer roller 112, rather than through electrostatic forces.

A pre-transfer erasing unit 110 removes the charges from the portion (non-image region) of the photosensitive body 101, on which the color toner images are not formed, before transferring the color toner images on the photosensitive body 101 onto the transfer belt 105. The pre-transfer erasing unit 110 improves the transfer efficiency from the photosensitive body 101 to the transfer belt 105.

An erasing lamp 107 is an example of an eraser for removing charges remaining on the peripheral surface of the photosensitive body 101 before performing the charging operation. The erasing lamp 107 irradiates light having a predetermined wavelength onto the peripheral of the photosensitive body 101 to remove any charges remaining on the surface of the photosensitive body 101.

A high voltage power supply unit 108 provides power at various voltages to components mounted in the image forming apparatus 100, such as a development bias voltage for transferring color toner from the developers 104C, 104M, 104Y, and 104K onto the photosensitive body 101, a development preventing bias voltage for preventing color toner from transferring from the developers 104C, 104M, 104Y, and 104K onto the photosensitive body 101, a first transfer bias voltage for transferring the color toner images from the photosensitive body 101 onto the transfer belt 105, a second transfer bias voltage for transferring toner images from the transfer belt 105 onto sheets (S), and a charging voltage provided to the charging roller 102.

The fixing unit 111 fixes the color toner image onto the sheet (S) by applying heat and pressure to the color toner images transferred onto the sheet (S), and includes a heat roller 123 and a pressing roller 124. The heat roller 123 is a heat source for permanently fixing the color toner images and faces the pressing roller 124, in an axial direction. The pressing roller 124 faces the heat roller 123 and applies high pressure to the sheet (S) to fix the color toner images onto the sheet (S).

A discharge roller 117 discharges the sheet (S) onto which the toner image is fixed from the image forming apparatus 100. The sheet (S) discharged from the image forming apparatus 100 is loaded on a discharge tray 180.

The image forming apparatus 100 includes a sheet-feeding cassette 113a, which is an example of a loading means for loading sheets (S). The loading means may include a second sheet feeding cassette 113b which can additionally load sheest (S) and a multi-purpose feeder (MPF) 113c. The MPF 113c is mainly used for conveying overhead projector transparencies or other non-standardized sheets (S).

A feed roller 116 conveys sheets (S) from the sheet feeding cassettes 113a, 113b, 113c to the sheet conveying unit 120 by pickup rollers 115a, 115b and 115c.

The sheet conveying unit 120 includes a sheet feeding path 121 for guiding the sheet (S) between the feed roller 116 and the fixing unit 111, and a duplex path 122 for duplex printing. The sheet conveying unit 120 is provided with a registration roller 118. The registration roller 118 registers the sheet (S) such that the color toner images can be transferred onto a desired portion of the sheet (S), before the sheet (S), which is conveyed from the feed roller 116, passes between the transfer belt 105 and the transfer roller 112. The conveyed sheet (S) passes between the transfer belt 105 and the transfer roller 112 such that the color toner images are transferred onto the sheet (S). The toner image transferred onto the sheet (S) is fixed to the sheet (S) by the fixing unit 111, and the sheet (S) is discharged from the image forming apparatus 100 by the discharge roller 117.

For duplex printing, the discharge roller 117 rotates reversely and the sheet (S) is conveyed along the duplex path 122. The sheet (S) is reversed, and the reversed sheet (S) is conveyed along the sheet feeding path 121 by the feed roller 116 so that the color image is printed on the back surface of the sheet (S).

The operation of the image forming apparatus 100 according to an exemplary embodiment of the present invention will be described in detail. A full color image is composed by mixing cyan (C), magenta (M), yellow (M), and black (K) color toner images. In the present embodiment, the color toner images are mixed by overlapping the single color images on the transfer belt 105 in the order of cyan (C), magenta (M), yellow (M) and then black (K). The overlapped, full color image is then transferred and fixed onto the sheet (S) to form the color image.

The peripheral surface of the photosensitive body 101 is charged to a uniform potential by the charging roller 102. When an optical signal corresponding to the cyan image is scanned onto the rotating photosensitive body 101 by the light scanning unit 103, the resistance of the portion onto which the light is scanned is reduced and the charge on the peripheral surface of the photosensitive body 101 is removed. Accordingly, a potential difference is generated between the portion onto which light is scanned and the portion onto which light is not scanned, thereby forming an electrostatic latent image on the peripheral surface of the photosensitive body 101.

When the electrostatic latent image approaches the cyan developer 104C due to the rotation of the photosensitive body 101, the development roller 125 of the cyan developer 104C begins to rotate and the high voltage power supply unit 108 applies a development bias voltage to the development roller 125 of the cyan developer 104C. The high voltage power supply unit 108 also applies a development preventing bias voltage for preventing image development to the development rollers 125 of the other developers 104M, 104Y, and 104K. The cyan toner traverses the development gap (Dg) and adheres to the electrostatic latent image formed on the peripheral surface of the photosensitive body 101, thereby forming a cyan (C) toner image.

When the cyan (C) toner image approaches the transfer belt 105 due to the rotation of the photosensitive body 101, the toner image is transferred onto the transfer belt 105 due to the first transfer bias voltage on the middle transfer roller 105b, or due to contact pressure between the photosensitive body 101 and the transfer belt 105.

After the cyan toner image is completely transferred onto the transfer belt 105, magenta (M), yellow (M), and black (K) toner images are developed and transferred onto the transfer belt 1050 in a similar way. The individual color images are overlapped to form a full color image. During this process, the developer driving apparatus 200 drives the developers (104C, 104M, 104Y, and 104K) such that the image development is accomplished by the above-mentioned operations.

During the above-mentioned process, the transfer roller 112 is spaced from the transfer belt 105. Once all four colors of toner images are transferred and overlapped onto the transfer belt 105 to form a full color toner image on the transfer belt 105, the transfer roller 112 contacts the transfer belt 105 to transfer the color toner image to the sheet (S).

The sheet (S) is supplied from the sheet feeding cassette 113a (or the sheet feeding cassette 113b or the MPF 113c) so that the top end of the sheet (S) approaches the point where the transfer belt 105 contacts the transfer roller 112 at substantially the same time that the top end of the color toner images formed on the transfer belt 105 approaches the point where the transfer belt 105 contacts the transfer roller 112. When the sheet passes through the space between the transfer belt 105 and the transfer roller 112, the color toner images are transferred onto the sheet (S) by the second transfer bias voltage, and the transferred images are fixed onto the sheet (S) by heat and pressure in the fixing unit 111. Then, the sheet (S) on which the color image is formed is discharged, thereby finishing the color image forming process.

For the next printing, the first and second cleaning units 106 and 109 remove any waste toner remaining on the photosensitive body 101 and the transfer belt 105, and the erasing lamp 107 irradiates light onto the photosensitive body 101 to remove any charges remaining on the photosensitive body 101.

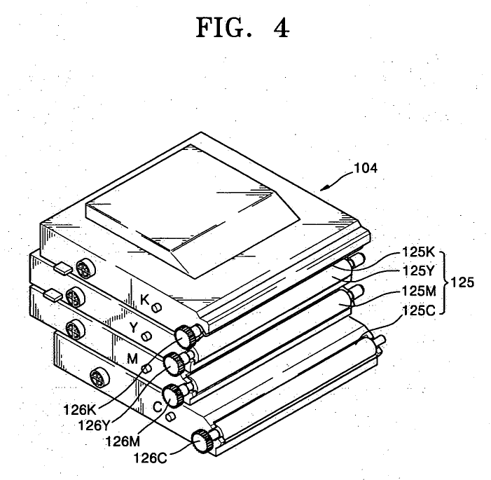

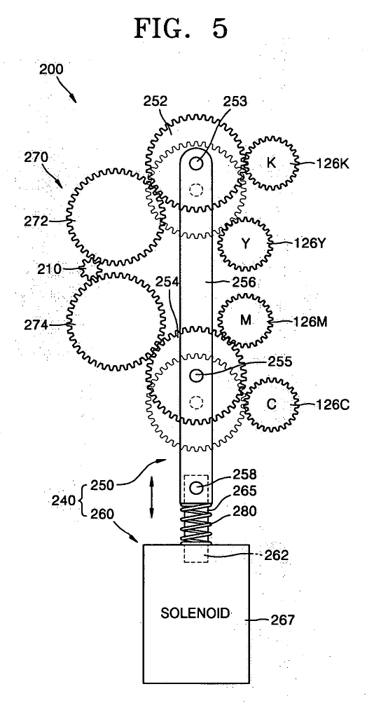

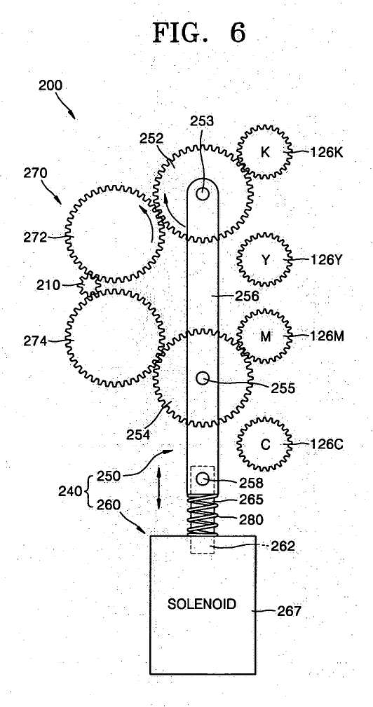

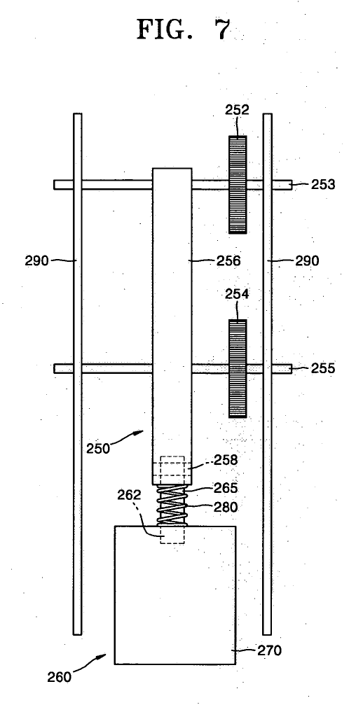

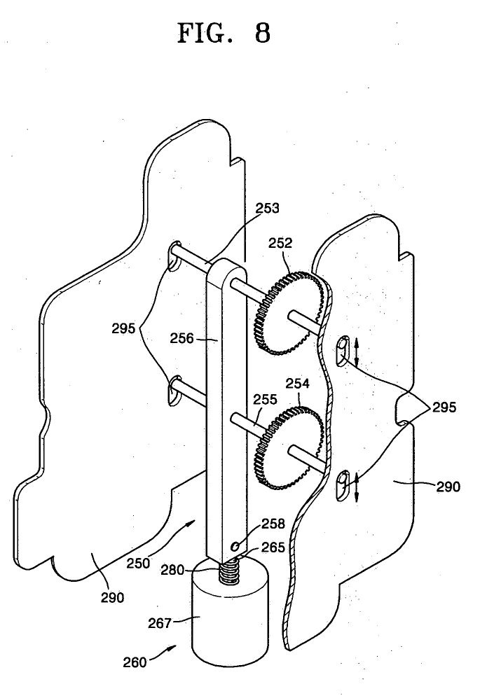

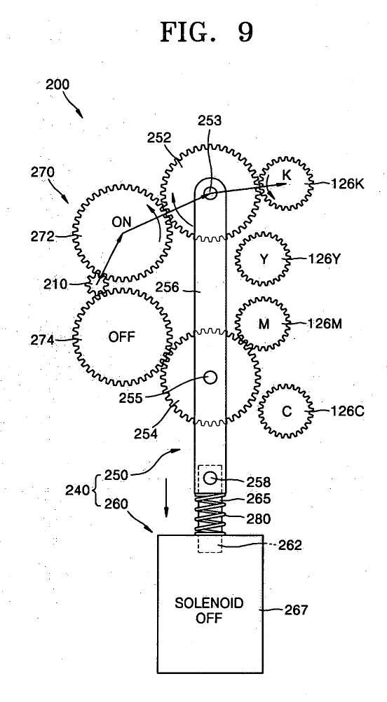

A developer driving apparatus 200 according to an exemplary embodiment of the present invention will now be described in detail. FIG. 4 is a perspective view of the developers 104 illustrated in FIG. 3. FIG. 5 illustrates the structure of a developer driving apparatus according to an exemplary embodiment of the present invention. FIG. 6 illustrates the structure of another developer driving apparatus according to an exemplary embodiment of the present invention. FIG. 7 illustrates the developer driving apparatus illustrated in FIG. 5 coupled to a bracket. FIG. 8 is a perspective view of FIG. 7. FIGS. 9 to 12 illustrate the operation of a developer driving apparatus according to an exemplary embodiment of the present invention.

Referring to FIG. 4, in the illustrated embodiment, the four developers 104C, 104M, 104Y, and 104K are arranged in the ascending color order of cyan, magenta, yellow, and black, and form a C-shape. The developer driving apparatus 200 of the present invention may also be used when the four developers 104C, 104M, 104Y, and 104K are arranged in an substantially straight line, as shown in FIG. 6. These embodiments are only illustrative, however, and the present invention is not limited to any particular shape.

Referring to FIGS. 4 and 5, the developer driving apparatus 200 according to the exemplary embodiment of the present invention selectively drives the developers 104C, 104M, 104Y, and 104K to develop an electrostatic latent image formed on the photosensitive body 101 with a predetermined color. The developer driving apparatus 200 includes a driving source 210, a power transmitting unit 240, and a power controlling unit 270.

The driving source 210 generates driving power for driving the developers 104C, 104M, 104Y, and 104K. A driving motor (which rotates in a predetermined direction) may be used as the driving source 210.

The power transmitting unit 240 selectively transmits the power generated by the driving source 210 to the development rollers 125 of the developers 104C, 104M, 104Y, and 104K to drive the developers 104C, 104M, 104Y, and 104K. That is, the power transmitting unit 240 selectively transmits power to the development roller gears 126C, 126M, 126Y, and 126K (which are provided on the shafts of the development rollers 125) to drive the corresponding developers 104C, 104M, 104Y, and 104K. The power transmitting unit 240 drives the developers 104C, 104M, 104Y, and 104K by selectively being placed into contact with or being separated from the development rollers 125 of the developers 104C, 104M, 104Y, and 104K. In other words, the power transmitting unit 240 reciprocates between predetermined locations to be placed into contact with or be separated from the development roller gears 126C, 126M, 126Y, and 126K to drive the developers 104C, 104M, 104Y, and 104K.

The power transmitting unit 240 includes a development roller driving unit 250 and a controlling unit 260. The development roller driving unit 250 reciprocates to selectively transmit the power controlled by the power controlling unit 270 to the development rollers 125 of the developers 104C, 104M, 104Y, and 104K.

The development roller driving unit 250 includes power transmitting gears 252 and 254 and an arm 256. The power transmitting gears 252 and 254 receive power from the power controlling unit 270 and transmit the power to the development rollers 125 of the developers 104C, 104M, 104Y, and 104K. The power transmitting gears 252 and 254 includes first and second power transmitting gears 252 and 254 which rotate in engagement with the development roller gears 126C, 126M, 126Y, and 126K. For convenience, the development roller mounted on the black developer 104K, the development roller mounted on the yellow developer 104Y, the development roller mounted on the magenta developer 104M, and the development roller mounted on the cyan developer 104C are referred to as a first development roller 125K, a second development roller 125Y, a third development roller 125M and a fourth development roller 125C, respectively. The first power transmitting gear 252 reciprocates between the first and second development rollers 125K and 125Y to selectively drive the development rollers 125K and 125Y. The second power transmitting gear 254 reciprocates between the third and fourth development rollers 125M and 125C to selectively drive the development rollers 125M and 125C. It should be understood that the particular arrangement of the development roller gears 126C, 126M, 126Y, and 126K and the first and second power transmitting gears 252 and 254 in the above-mentioned structure is only an illustrative embodiment of the present invention, and the present invention is not limited to this particular arrangement.

The power transmitting gears 252 and 254 are coupled onto the shafts 253 and 255, and the shafts are rotatably inserted into the arm 256, which is reciprocated between predetermined locations by the controlling unit 260. The power transmitting gears 252 and 254 are selectively placed into contact with or separated from the development roller gears 126C, 126M, 126Y, and 126K by the reciprocation of the arm 256 to transmit the power generated by the driving source 210 to the corresponding one of the developers 104C, 104M, 104Y, and 104K. One end of the arm 256 is rotatably coupled to the controlling unit 260, and the arm 256 transmits the reciprocal movement of the controlling unit 260 to the power transmitting gears 252 and 254 through a coupling part.

The controlling unit 260 controls the reciprocation of the development roller driving unit 250 so that the development roller driving unit 250 is selectively placed into contact with or separated from the development rollers 125 of the developers 104C, 104M, 104Y, and 104K (that is, the development roller gears 126C, 126M, 126Y, and 126K). The controlling unit 260 includes a plunger 265, which is coupled (258) to one end of the arm 256 and reciprocally moves the arm 256, and a solenoid 267, into and out of which the plunger 265 reciprocates. The solenoid 267 is provided with a guide hole 262 where the plunger 265 reciprocates.

The solenoid 267 is turned on or off to move the plunger 265. When the solenoid 267 is turned on, the plunger 265 is moved into the guide hole 262 of the solenoid 267. At this time, the first and second power transmitting gears 252 and 254 are respectively engaged with the second and fourth development roller gears 126Y and 126C. When the solenoid 267 is turned off, the plunger 265 moves out of the guide hole 262 of the solenoid 267. At this time, the first and second power transmitting gears 262 and 254 are respectively engaged with the first and third development roller gears 126K and 126M.

An elastic member 280 may be provided between one end of the arm 256 and the solenoid 267. For example, an elastic member 280 can surround the periphery of the plunger 265 to provide an elastic bias force to one end of the arm 256. That is, the elastic member 280 provides an elastic bias force which is directed towards the development roller driving unit 250 such that the plunger 265 moves away from the solenoid 267 when the solenoid 267 is turned off.

The power controlling unit 270 provided between the driving source 210 and the power transmitting unit 240 selectively controls the power such that the power is transmitted to the developers 104C, 104M, 104Y, and 104K. The power controlling unit 270 includes a first power controlling unit 272 for controlling the power transmitted to the first power transmitting gear 252 and a second power controlling unit 274 for controlling the power transmitted to the second power transmitting gear 254. It is preferable that the power controlling unit 270 includes an electronic clutch. The structure of a power controlling unit 270 that uses an electronic clutch is widely known and therefore a detailed description is omitted for conciseness.

In the present embodiment, the power is controlled using the power controlling unit 270 to selectively transmit the power to the developers 104C, 104M, 104Y, and 104K. This is, however, only an embodiment of the present invention and should not be construed to limit the scope of the present invention.

In another embodiment, not illustrated, a driving source rotates forward or backward to drive the developers, and a power controlling unit selectively transmits power generated by the driving source to the power transmitting unit. The power controlling unit includes first and second power controlling units, and the first and second power controlling units include a plurality of one-way gears for transmitting torque in only one direction. The development rollers can be selectively driven by arranging the one-way gears so that they transmit power according to the forward and backward rotation of the driving source appropriately.

For convenience and clarity, FIGS. 7 and 8 only show the power transmitting unit and a bracket 290. The developer driving apparatus 200 according to the present invention may further include a bracket 290 for guiding the reciprocal movement of the power transmitting unit 240. The power transmitting unit 240 is coupled to the bracket 290 so that it can reciprocate. The bracket is provided with guide holes 295 for reciprocally moving the power transmitting unit 240. That is, the shafts 253 and 255 of the first and second power transmitting gears 252 and 254 are inserted into the guide holes 295 in the bracket 290. Preferably, a pair of brackets 290 is used to provide more stable support to the shafts 253 and 255.

The guide holes 295 may be formed in a curved shape so that the first and second power transmitting gears 252 and 254 are selectively engaged with the development roller gears 126C, 126M, 126Y, and 126K according to the arrangement of the developers 104C, 104M, 104Y, and 104K. This example is provided for illustrative purposes only, and should not be construed as a limitation on the scope of the present invention.

The operation of the developer driving apparatus 200 according to the exemplary embodiment of the present invention will now be described in detail. Referring to FIG. 3, when the charging roller 102 charges the photosensitive body 101 to a uniform potential, the light scanning unit 103 irradiates light onto the peripheral surface of the photosensitive body 101 to form an electrostatic latent image of an image to be developed on the peripheral surface of the photosensitive body 101 with a first color. In the present embodiment, for convenience of description, it will be assumed that the developers are driven in order of the first developer 104K, the second developer 104Y, the third developer 104M and the fourth developer 104C.

Referring to FIG. 9, when the first developer 104K is driven, the first power controlling unit 272 is turned on to transmit the power generated by the driving source 210 to the power transmitting unit 240, that is, the first power transmitting gear 252. The first power transmitting gear 252 transmits the power generated by the driving source 210 to the first development roller gear 126K to drive the first developer 104K. That is, the power generated by the driving source 210 is transmitted to the first power controlling unit 272, the first power transmitting gear 252, the first development roller gear 126K, the first development roller 125K, and the first developer 104K. At this time, the second power transmitting gear 254 is also engaged with the third development roller gear 126M, but the power generated by the driving source 210 is not transmitted to the second power transmitting gear 254, because the second power controlling unit 274 is in an OFF state. Accordingly, the third developer 104M does not operate. The black development is performed by the above-described process.

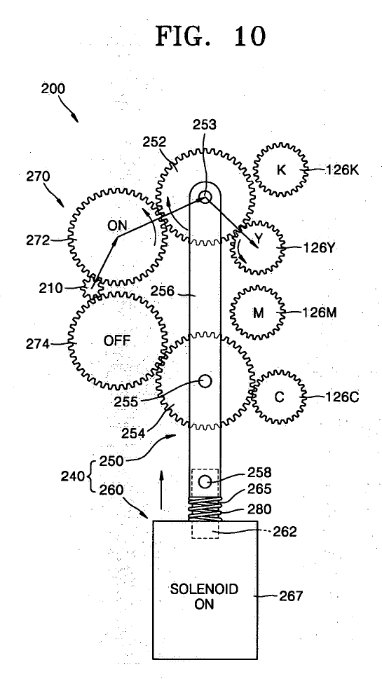

Referring to FIG. 10, after the black development is finished, the yellow development is performed. In this case, the solenoid 267 is turned on and thus the plunger 265 is moved into the guide hole 262 of the solenoid 267. At this time, the arm 256 that is coupled (258) with the plunger 265 is moved to a predetermined location in connection with the movement of the plunger 265. Referring to FIG. 10, as the arm 256 moves, the first and second power transmitting gears 252 and 254 are engaged with the second and fourth development roller gears 126Y and 126C. At this time, since the first power controlling unit 272 is in an ON state and the second power controlling unit 274 is in an OFF state, the power generated by the driving source 210 is transmitted only to the first power transmitting gear 252. Accordingly, the first power transmitting gear 252 transmits the power generated by the driving source 210 to the second development roller gear 126Y to drive the second developer 104Y. That is, the power generated by the driving source 210 is transmitted to the driving source 210, the first power controlling unit 272, the first power transmitting gear 252, the second development roller gear 126Y, the second development roller 125Y, and the second developer 104Y. At this time, the second power transmitting gear 254 is also engaged with the fourth development roller gear 126C, but the power generated by the driving source 210 is not transmitted to the second power transmitting gear 254 because the second power controlling unit 274 is in an OFF state. Accordingly, the fourth developer 104C does not operate. The yellow development is performed by the above-described process.

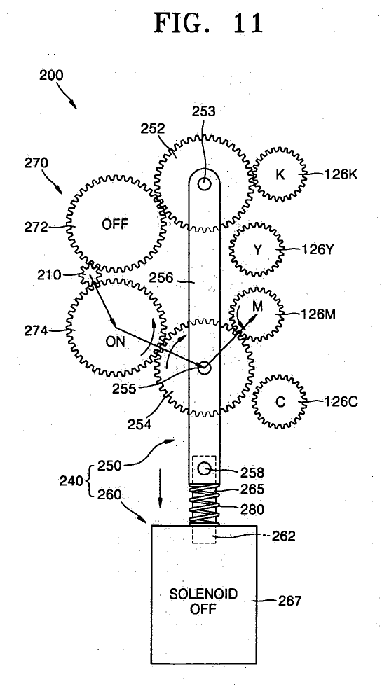

Referring to FIG. 11, when the yellow development is finished, the magenta development is performed. In this case, the solenoid 267 is turned off and thus the plunger 265 is moved out of the guide hole 262 of the solenoid 267. At this time, the arm 256 that is coupled (258) with the plunger 265 is moved to a predetermined location in connection with the movement of the plunger 265. Referring to FIG. 11, as the arm 256 moves, the first and second power transmitting gears 252 and 254 are engaged with the first and third development roller gears 126K, 126M. At this time, since the first power controlling unit 262 is in an OFF state and the second power controlling unit 274 is in an ON state, the power generated by the driving source 210 is transmitted only to the second power transmitting gear 254. Accordingly, the second power transmitting gear 254 transmits the power generated by the driving source 210 to the third development roller gear 126M to drive the third developer 104M. That is, the power generated by the driving source 210 is transmitted to the driving source 210, the second power controlling unit 274, the second power transmitting gear 254, the third development roller gear 126M, the third development roller 125M, and the third developer 104M. At this time, the first power transmitting gear 252 is also engaged with the first development roller gear 126K, but the power generated by the driving source 210 is not transmitted to the first power transmitting gear 252 because the first power controlling unit 272 is in an OFF state. Accordingly, the first developer 104K does not operate. The magenta development is performed by the above-described process.

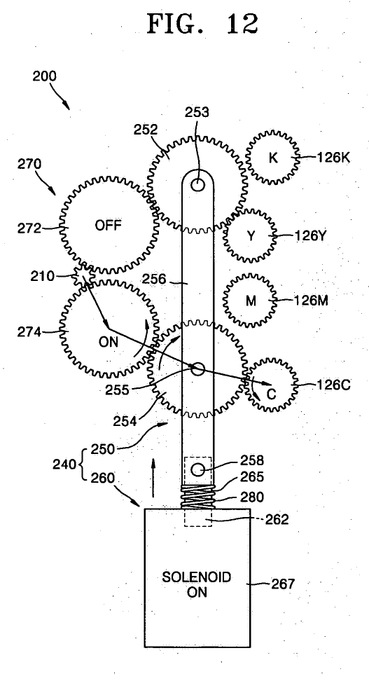

Referring to FIG. 12, when the magenta development is finished, the cyan development is performed. In this case, if the magenta development is finished, the solenoid 267 is turned on and thus the plunger 265 is moved into the guide hole 262 of the solenoid 267. At this time, the arm 256 that is coupled (258) with the plunger 265 is moved to a predetermined location in connection with the movement of the plunger 265. Referring to FIG. 12, as the arm 256 moves, the first and second power transmitting gears 252 and 254 are engaged with the second and fourth development roller gears 126Y and 126C. At this time, since the first power controlling unit 272 is in an OFF state and the second power controlling unit 274 is in an ON state, the power generated by the driving source 210 is transmitted only to the second power transmitting gear 254. Accordingly, the second power transmitting gear 254 transmits the power generated by the driving source 210 to the fourth development roller gear 126C to drive the third developer 104C. That is, the power generated by the driving source 210 is transmitted to the driving source 210, the second power controlling unit 274, the second power transmitting gear 254, the fourth development roller gear 126C, the fourth development roller 125C, and the fourth developer 104C. At this time, the first power transmitting gear 252 is also engaged with the second development roller gear 126Y, but the power generated by the driving source 210 is not transmitted to the first power transmitting gear 252 because the first power controlling unit 272 is in an OFF state. Accordingly, the second developer 104Y does not operate. The cyan development is performed by the above-described process.

As described above, the developer driving apparatus 200 selectively drives the developers 104C, 104M, 104Y, and 104K to develop the corresponding color image. By repeating the above-mentioned processes, the electrostatic latent image formed on the photosensitive body 101 is developed into a visible color image.

Alternatively, the first power controlling unit 272 and the second power controlling unit 274 may be alternately turned on to drive the first and third developers 104K and 104M when the solenoid 267 is turned off. Then, when the solenoid 267 is turned on and the first and second power transmitting gears 252 and 254 are engaged with the second and fourth development roller gears 126Y and 126C, the first power controlling unit 272 and the second power controlling unit 274 may be alternately turned on to drive the second and fourth developers 104Y and 104C.

The developer driving apparatus 200 of the present invention can selectively drive the developers 104C, 104M, 104Y, and 104K using two power controlling units 272 and 274, that is, two electronic clutches, unlike a conventional driving apparatus. Alternatively, in the developer driving apparatus 200 according to the present invention, a plurality of the power transmitting gears may be arranged among the driving source 210, the power controlling unit 270, and the power transmitting unit 240 to transmit the power from the driving source 210 to the developers 104C, 104M, 104Y, and 104K.

Accordingly, the manufacturing cost of the image forming apparatus can be reduced. Also, the number of the power controlling units can be reduced and, the corresponding space occupied by the power controlling units is no longer needed. Accordingly, the developer driving apparatus and the image forming apparatus can be made more compact.

While the invention has been shown and described with reference to certain embodiments thereof, it will be understood by those skilled in the art that various changes in form and details may be made therein without departing from the spirit and scope of the invention as defined by the appended claims.

What is claimed is:

1. A developer driving apparatus for an image forming apparatus, which selectively operates a plurality of developers to develop an electrostatic latent image formed on a photosensitive body with a predetermined color, the developer driving apparatus comprising:
a driving source;
a power transmitting unit selectively transmitting power generated by the driving source to development rollers of the developers to drive the developers; and
a power controlling unit provided between the driving source and the power transmitting unit and controlling the power so that the power is transmitted to the corresponding developer.

2. The developer driving apparatus according to claim 1, wherein
the power transmitting unit is selectively placed into contact with or separated from the development rollers of the developers.

3. The developer driving apparatus according to claim 2, wherein the power transmitting unit comprises:
a development roller driving unit that moves between predetermined locations to selectively transmit the power controlled by the power controlling unit to the development rollers of the developers; and
a controlling unit for controlling the movement of the development roller driving unit such that the development roller driving unit is selectively placed into contact with or separated from the development rollers of the developers.

4. The developer driving apparatus according to claim 3, wherein the development roller driving unit comprises:
power transmitting gears receiving the power from the power controlling unit and transmitting the power to the development rollers of the developers; and
an arm that rotatably receives a shaft to which the power controlling unit is coupled.

5. The developer driving apparatus according to claim 4,
wherein the power transmitting gears include first and second power transmitting gears and the development roller include first, second, third, and fourth development rollers, and
wherein the first power transmitting gear moves between the first and second development rollers to selectively drive the development rollers and the second power transmitting gear moves between the third and fourth development rollers to selectively drive the development rollers.

6. The developer driving apparatus according to claim 5, wherein
one end of the arm is rotatably coupled to the controlling unit.

7. The developer driving apparatus according to claim 6, wherein the controlling unit comprises:
a plunger coupled to one end of the arm for moving the arm; and
a solenoid into and out of which the plunger moves.

8. The developer driving apparatus according to claim 7, wherein
when the solenoid is turned on and the plunger is moved into the solenoid, the first and second power transmitting gears are engaged with the gears provided at the second and fourth development rollers, and
when the solenoid is turned off and the plunger is moved out of the solenoid, the first and second power transmitting gears are engaged with the gears provided at the first and third development rollers.

9. The developer driving apparatus according to claim 8, further comprising:
an elastic member providing an elastic force such that the plunger moves out of the solenoid when the solenoid is turned off.

10. The developer driving apparatus according to claim 9, wherein the power controlling unit comprises:
a first power controlling unit controlling the power transmitted to the first power transmitting gear; and
a second power controlling unit controlling the power transmitted to the second power transmitting gear.

11. An image forming apparatus including a developer driving apparatus for selectively operating a plurality of developers to develop an electrostatic latent image formed on a photosensitive body with a predetermined color, wherein the developer driving apparatus comprises:
a driving source;
a power transmitting unit selectively transmitting power generated by the driving source to development rollers of the developers to drive the developers; and
a power controlling unit provided between the driving source and the power transmitting unit and controlling the power so that the power is transmitted to the corresponding developer.

12. The image forming apparatus according to claim 11, wherein
the power transmitting unit is selectively placed into contact with or separated from the development rollers of the developers.

13. The image forming apparatus according to claim 12, wherein the power transmitting unit comprises:
a development roller driving unit that moves between predetermined locations to selectively transmit the power controlled by the power controlling unit to the development rollers of the developers; and
a controlling unit for controlling the movement of the development roller driving unit such that the development roller driving unit is selectively placed into contact with or separated from the development rollers of the developers.

14. The image forming apparatus according to claim 13, wherein the development roller driving unit comprises:
power transmitting gears receiving the power from the power controlling unit and transmitting the power to the development rollers of the developers; and
an arm that rotatably receives a shaft to which the power controlling unit is coupled.

15. The image forming apparatus according to claim 14,
wherein the power transmitting gears include first and second power transmitting gears and the development rollers include first, second, third, and fourth development rollers, and
wherein the first power transmitting gear moves between the first and second development rollers to selectively drive the development rollers and the second power transmitting gear moves between the third and fourth development rollers to selectively drive the development rollers.

16. The image forming apparatus according to claim 15, wherein
one end of the arm is rotatably coupled to the controlling unit.

17. The image forming apparatus according to claim 16, wherein the controlling unit comprises:
a plunger coupled to one end of the arm for moving the arm; and
a solenoid into and out of which the plunger moves.

18. The image forming apparatus according to claim 17, wherein
when the solenoid is turned on and the plunger is moved into the solenoid, the first and second power transmitting gears are engaged with the gears which are provided at the second and fourth development rollers, and
when the solenoid is turned off and the plunger is moved out of the solenoid, the first and second power transmitting gears are engaged with the gears which are provided at the first and third development rollers.

19. The image forming apparatus according to claim 18, further comprising:
an elastic member providing an elastic force such that the plunger moves out of the solenoid when the solenoid is turned off.

20. The image forming apparatus according to claim 19, wherein the power controlling unit comprises:
a first power controlling unit controlling the power which is transmitted to the first power transmitting gear; and
a second power controlling unit controlling the power which is transmitted to the second power transmitting gear.
